(19) United States
(12) Patent Application Publication
(10) Pub. No.: US 2006/0165464 A1
(43) Pub. Date: Jul. 27, 2006

(54) Training system and method for learning typing

(75) Inventors: Zechary Chang, Taipei (TW); Harry Han, Beijing (CN)

Correspondence Address: HDSL, 4331 STEVENS BATTLE LANE, FAIRFAX, VA, 22033, US

(73) Assignee: Inventec Corporation

(21) Appl. No.: 11/043,103

(22) Filed: Jan. 27, 2005

(51) Int. Cl. B41J 5/14

(52) U.S. Cl. 400/472

(57) ABSTRACT

A training system and method for a user to effectively learn typing in a correct fingering manner provides the user a finger-mountable sensor device, upon a user typing a key, they will compare signals generated by the key stroked and by the sensor of the typing finger and indicates whether a right key is stroked by the right finger or in the right manner.

### FIELD OF THE INVENTION

The invention generally relates to a training system and method for users to learn typing, used in computer systems with keyboard input device, where plural sensors are mounted on user's fingers.

### BACKGROUND OF THE INVENTION

Due to widespread information technology and Internet, computer applications have been incorporated and used in every aspect of business and people's daily life. The keyboard input is the main input method to communicate between a user and the computer. Thus it is important to learn typing properly. Through proper training a user will become more effective in using computers and improve efficiency.

Most typing training software packages on the market focus only on the speed and correctness of typing, none of them trains the user in finger positioning (or fingering). Although speed and accurate typing are key elements of efficient typing, nevertheless, incorrect typing positions may cause injuries and even permanent injuries in the user's wrist. Therefore, how to guide the user properly and intuitively during typing excises becomes an important subject.

Most of the software provides a static map and requires the user to remember finger positions before the user actually starts a typing exercise, during the exercise, these software can only monitor the speed and correctness of one's typing but not one's figure position. Once a user gets used to type in improper figure positions, it will result in a prolonged learning time. It creates a bottleneck in increasing speed as well.

### SUMMARY OF THE INVENTION

The object of the invention is to provide a training system and method for a user to effectively learn typing in a correct fingering manner, besides typing speed and accuracy.

The invention includes a keyboard input device and a finger sensor device, where a keyboard input device connects to a computer system and has a plurality of keys; these keys are divided into multiple regions and each region corresponds to a finger of the user; the sensor device include sensors to be mounted on user's fingers and a signal converter. When the user is typing, two signals will be generated; the first one is from the key being pressed, the second one is generated from the sensor on the finger when the figure presses the key and the pressure to the figure is converted by the converter into a digital signal for comparison purpose. Once the computer system receives both signals, not the system will record the speed and correction of the key, it also makes a judgment on whether a user is using the correct region of his figure to press the key; then the system shows the result to the user by a sound, image, picture or words. This way results in a rapid training purpose.

The objectives of the present invention will become obvious to those of skilled in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

Other objects, features, and advantages of the present invention will become apparent from the following detailed description of the preferred but non-limiting embodiment. The description is made with reference to the accompanying drawings in which:

FIG. 1 is a system functional block diagram of the present invention;

FIG. 2 is input regions defined on keyboard input device of the present invention;

FIG. 3 is a logical flow chart of the present invention; and

FIG. 4 is an example of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like portions.

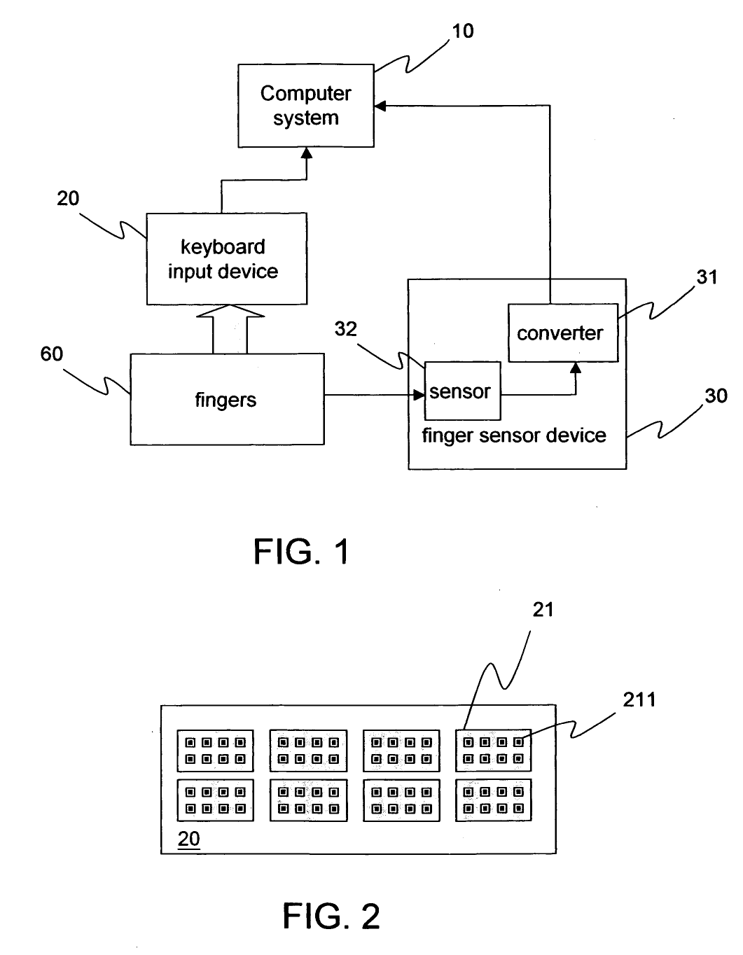

Referring to FIG. 1, the present invention includes a keyboard input device 20 connected to a computer system 10 and a finger sensor device 30, that a user can wear/attach on his hands and monitors the operation of his fingers 60 while typing. The sensor device includes at least one built-in sensor 32 and a signal converter 31. In general, each sensor corresponds to one of a user's fingers.

FIG. 2 illustrates a keyboard example, the keyboard input device 20 comprises a plurality of keys 211, divided into multiple input regions 21; each input region 21 has the same number of keys 211. Each input region 21 corresponds to one of the user's fingers, so that usually ten input regions 21 should used. The definition of the input region 21 can be defined by software instead of hardware on the keyboard-input device 20.

During practice, when the user's finger strikes a key 211 on the keyboard input device 20, a signal is generated corresponding to the letter key or number key being hit. Moreover, the sensors 32 will sense which finger strikes the key, either by pressure, static electricity or vibration method. For example, assume that the sensor 32 is a pressure-sensor, it will sense the press exerted when hitting a key 211. Or for vibration, it will sense the vibration. As for static electricity, it will depend on existing static changes on the human body to make a decision.

The striking signal generated by the sensor 32 is converted by the converter 31 into a digital comparison signal, and then transferred to a computer system 10. The computer 10 will decide which input region it belongs to, and which finger is being used. Next, the computer determines if the input region matches the finger being used and shows the result to the user, so that the user will learn from his/her mistakes.

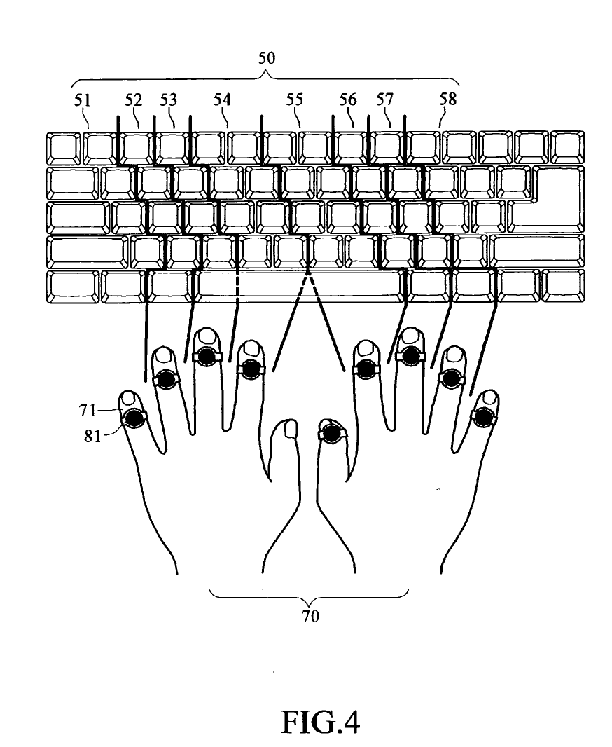

Referring FIG. 4, normally a keyboard 50 can be divide into 8 regions, that is: a first input region 51, second region 52, third region 53, fourth region 54, fifth region 55, sixth region 56, seventh region 57 and an eighth region 58. These regions match to the user's middle, ring fingers and pinks, and each of these fingers wears a sensor 81. For example, the left pink 71 corresponds to first input region 51, and when the pink 71 hits any key in the first region 51, i.e. [A] (not shown in the Fig), a corresponding input signal will be received by the computer. Also, through a sensor 81, a computer is notified that the user has used his pink 71 to hit the key. Since it falls with a designated region, the input finger is correct. If, instead, the pink hits the [S] key, which belongs to the second input region 52, the key should be hit by the ring finger; once the error is found, the result will be forwarded to the user so that he/she can correct the error.

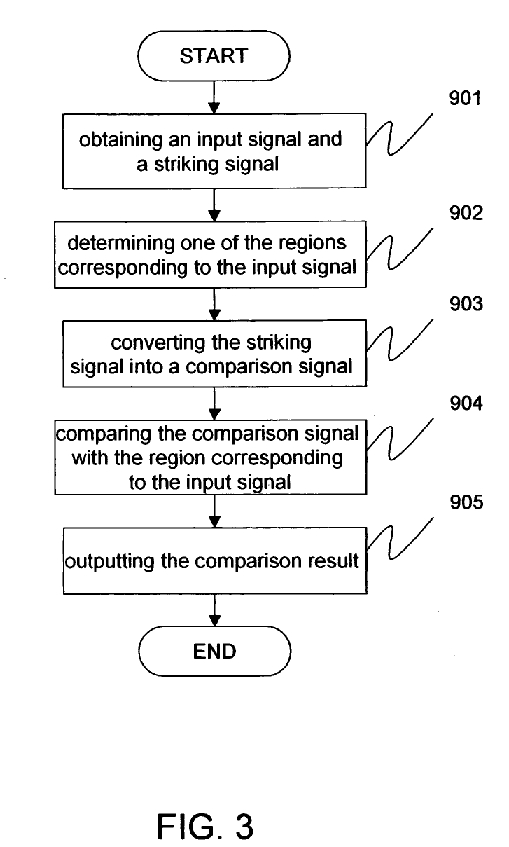

Referring to FIG. 3, using the present invention: when a user presses a key on the keyboard input device, the computer system will receive two signals, one input signal and one striking signal (step 901), where the input signal corresponds to the key being pressed by the user and a striking signal corresponds to the finger being used to hit the key. Then, the system will determine which region the input signal belongs to (step 902), and converts the striking signal to a comparison signal (step 903). Next, after comparing the comparison signal with the input signal (step 904), the computer will decide if the used finger belongs to the region indicated by the input signal. Finally, the result is displayed to the user by a sound, image, picture or words to the user (step 905), which reminds the user to use his fingers correctly.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A typing training system, comprising:
a keyboard input device, connecting to a computer system, having a plurality of keys grouped into a plurality of regions, where each region is assigned to one corresponding finger of a typing user; and
a sensor device, having at least of one sensor and a signal converter, where said sensors device are mounted on fingers of said typing user;
wherein upon striking said key on the keyboard input device by an input-finger of the typing user, the computer system receives an input signal generated by the keyboard input device, the converter converts a striking signal generated by the sensor corresponding to the input-finger into a comparison signal and transmits the comparison signal to the computer system for comparing one of the regions corresponding to the input signal and the comparison signal.

2. The system of claim 1, wherein the number of said sensors equals to the number of said input regions.

3. The system of claim 1, wherein the number of said sensors and the number of said input regions are not greater than number of the fingers of said typing user.

4. The system of claim 1, wherein said sensors are pressure sensors, and said striking signal is obtained from a pressure exerted when striking said key on the keyboard input device.

5. The system of claim 1, wherein said sensors are vibration sensors, and said striking signal is obtained from the vibration received when striking said key on the keyboard input device.

6. The system of claim 1, wherein said sensors are static sensors, said striking signal is obtained from the static electricity changed when striking said key on the keyboard input device.

7. The system of claim 1, wherein said converter converts said striking signal into a digital comparison signal.

8. A typing training method, used in a computer system with a keyboard input device having a plurality of keys grouped into a plurality of regions, each assigned to one corresponding finger of a typing user, comprising the steps of:
obtaining an input signal and a striking signal by striking said keyboard input device by an input-finger of the typing user;
determining one of the regions corresponding to the input signal;
converting the striking signal into a comparison signal;
comparing the comparison signal with said region corresponding to the input signal and obtaining a comparison result; and
outputting said comparison result.

9. The method of claim 8, wherein said input signal is generated corresponding to said key on the keyboard input device stroked by the input-finger.

10. The method of claim 8, wherein said striking signal is generated by striking said keyboard input device by the input-finger of the typing user.

11. The method of claim 8, wherein said comparison signal is digital signal.

12. The method of claim 8, wherein said comparison result is shown in form of sound.

13. The method of claim 8, wherein said comparison result is in form of image.

14. The method of claim 8, wherein said comparison result is in form of picture.

15. The method of claim 8, wherein said comparison result is in form of words.
